(19) United States
(12) Patent Application Publication
(10) Pub. No.: US 2002/0087378 A1
(43) Pub. Date: Jul. 4, 2002

(54) System and method for estimating costs, ordering products, and managing resources

(76) Inventor: Brian Como, Charlton, MA (US)

Correspondence Address: MAUREEN STRETCH, ATTORNEY AT LAW, 26 CHARLES STREET, NATICK, MA, 01760, US

(21) Appl. No.: 09/681,082

(22) Filed: Dec. 29, 2000

(51) Int. Cl. G06F 17/60

(52) U.S. Cl. 705/8; 705/26

(57) ABSTRACT

The invention comprises a system and method for estimating costs, purchasing goods, and managing resources which includes a gap analysis, a contractor locator, an estimator, an automated auction option, a procurement function, and a resource manager which also enables the operation of virtual jobsite office.

### BACKGROUND OF INVENTION

1. Technical Field

This invention relates generally to computer implemented systems for estimating job costs and more particularly to systems for estimating job costs, ordering products and managing resources.

2. Background

In the construction industry in the United States, there are, at the time of this writing, approximately one hundred and eighty thousand contractor companies that can purchase construction goods and materials from around six thousand seven hundred distributors, which, in turn, buy from manufacturers. The contractors are often bound by precise municipal and state building codes and requirements, that vary widely from state to state, and from city to city. Some of the contractors are general contractor companies that hire others as subcontractors. Both general contractors and subcontractors face a number of problems: first, in estimating jobs as accurately as possible for all the variations by area; then in purchasing the right goods and materials for the jobs; also in selecting other contractors with which to work; and finally, managing the costs of goods, materials, and labor throughout the stages of construction, including disposing of any overstock after completion.

First, when estimating job costs it is desirable for the estimates for both goods and labor to be as close as possible to the likely actual costs for the particular area where the construction is contemplated.

If a large general contractor, or, for that matter, a smaller general contractor new to the area, wants to estimate the costs of a job in a new locale in order to submit a winning bid that will still be profitable, the task can be daunting. If a general contractor company is unfamiliar with the unique materials required by local zoning codes, it can inadvertently buy material which is unusable for the project.

For example, in California, building codes allow clay tile roofs, in the Northeastern US, shingles are used, while in the Midwest, metal roofing materials are allowable and used often. Building codes in the various other states or regions may or may not allow these materials to be used locally. Building codes in some states allow 2×10 inch floor joists while others require 2×12 inch floor joists. A national contractor unfamiliar with local codes can easily order the wrong materials for a project in a new area.

If the error is caught before the materials are incorporated in the work, this is still costly, because of the economics of this 680 Billion dollar industry (in the US).

If the error is not caught until the work is nearly completed, losses can mount rapidly as the amount of rework increases. In one example, wrong material was ordered and work was held up for two and a half weeks while replacement materials were purchased and brought to the site. In this example, rental equipment on-site, payroll for a crew unable to make progress without the materials, and late fees cost a contractor over $200,000.

In the construction industry, returns are costly—much of the material is specialized or somewhat unique. Manufacturers usually do not deal directly with contractors and prefer to sell through distributors. A distributor usually will not take a return back at all if the manufacturer will not take it back. Even if the manufacturer will accept returns, most distributors who accept returns from contractors charge a fifty percent restocking fee, and require the contractor to pay the freight. Thus, if a contractor paid $100.00 (USD) for an item that cannot be used at the site, a return might cost $50.00 in a restocking fee, plus $20.00 or more for freight. The odds are many contractors will not send the item back but will hold it as overstock.

In addition to the problems arising from the purchase of the wrong goods for a specific site, there are often major problems in getting the best information about the cost of goods in the locale. One company, RSmeans, does provide information about the price of goods in about 900 communities in the United States at its website, but the prices are list prices only, supplied with a cost adjustment factor for the area. In construction, most goods and materials are not sold at list but are significantly discounted. For each item that the general contractor needs, it may take several calls to local or regional suppliers to get a discounted price quote to use for the estimate. If there are hundreds of different items, handled by different distributors, it often takes many telephone calls and several weeks to compile a set of prices to use in the estimate and bid.

While wages may vary from city to city by some average percentage, there can also be significant variations in wage rates depending on the stage of construction. For example, in the initial stage of clearing and grubbing a site, heavier equipment is usually needed, operated by workers paid a fairly high hourly wage. In the final landscaping stage, smaller equipment is normally used, which can be operated by workers whose wages are at a lower hourly rate.

A larger general contractor may face similar problems in finding qualified subcontractors for the area. Subcontractors in Massachusetts, for example, are likely to be unknown to a general contractor based in California and vice-versa. Additionally, subcontractors may vary widely in experience levels and specialty areas. For example, there are several U.S. Standard Industrial Classifications (SIC) codes for contractors in the heating, ventilation, and air-conditioning (HVAC) industry, alone. SIC code 1711 is used for plumbing, heating and air-conditioning contractors, 7623 for refrigeration and air-conditioning service and repair shops, 3585 for air conditioning, warm-air heating equipment and commercial and industrial refrigeration-equipment manufacture, and 3433 for heating equipment, except electric- and warm-air-furnace manufacture. Wholesale SIC codes are 5074, plumbing and heating; 5075, warm-air heating and air conditioning; and 5078, refrigeration.

General construction-related SIC code differentiations include the following:

1521 Single-family housing construction

1522 Residential construction, (not elsewhere classified)

1531 Operative builders

1541 Industrial buildings and warehouses

1542 Nonresidential construction, (not elsewhere classified)

1611 Highway and street construction

1622 Bridge, tunnel, & elevated highway

1623 Water, sewer, and utility lines

1629 Heavy construction, (not elsewhere classified

1711 Plumbing, heating, air-conditioning

1721 Painting and paper hanging

1731 Electrical work

1741 Masonry and other stonework

1742 Plastering, drywall, and insulation

1743 Terrazzo, tile, marble, mosaic work

1751 Carpentry work

1752 Floor laying and floor work, (not elsewhere classified)

1761 Roofing, siding, and sheet metal work

1771 Concrete work

1781 Water well drilling

1791 Structural steel erection

1793 Glass and glazing work

1794 Excavation work

1795 Wrecking and demolition work

1796 Installing building equipment, (not elsewhere classified)

1799 Special trade contractors, (not elsewhere classified).

As can be seen, there is significant variation in the types of contractors and specialties. A given contractor company might also be involved in several related specialty areas, as well. Within the same SIC code, such as single-family housing, one contractor may have years of experience in tract development and starter home construction, while another may have years of experience in upscale home construction. A general contractor unfamiliar with the area may have to consult various listings of contractors by SIC code, then make many telephone calls to sift through the general information to find a few that might be good potential candidates for the project at hand. At present this process is labor intensive and takes hours, and more frequently days or weeks to complete.

While the above problems are found in the building materials and construction industry, there are other industries in which variations by state and locality significantly complicate matters for a company attempting to deal on a regional or national basis. The automotive industry for example, is affected by local variations more than may be apparent to the casual observer. Manufacturers sell regionally customized packages, such as cars with rear window defrosters and block heaters for cold climates such as Alaska, or northern New England. In Arizona and much of the US Southwest, air conditioning is a standard feature, not an option.

Insurance is regulated state by state, so policy costs and features vary as well. Automobile insurance costs also vary significantly from city to city within a state. Cars that are garaged in Chicago, Boston, New York or Los Angeles, are likely to be insured at higher premiums than those that are housed in suburban or rural areas. In many industries, there are variations from locale to locale that affect price, goods, labor, or all of these factors.

Thus, the number of significant variations that can be introduced by changed local conditions is highly significant for many industries. This makes estimating the cost of goods and services for projects such as construction in those areas complex and time consuming. Errors that are made either in estimating or purchasing, or both, can lead to lowered profits, increased losses and even loss of business.

Once a contract has been awarded, as a practical matter, a contractor needs to keep track of its inventory at various sites, so that equipment or goods or labor can be used elsewhere when the project or a phase at a given site is completed. This is typically done with wall charts, or paper logs at each site and telephone communications. This, in turn, means that job cost and equipment usage analyses are difficult to do and makes it less likely that the experiences gained in a completed project can be applied easily to refining estimates for future projects or to optimizing processes and profits.

It is an object of the present invention to provide an automated system for estimating the costs of goods and services for a locale that incorporates significant local variations that can affect such estimates.

It is another object of the present invention to provide an automated system for purchasing goods and services for a locale that incorporates significant local variations that might affect such purchases and alerts a buyer to them.

Still another object of the present invention is providing an automated resource management system for managing and tracking the use of goods and services at one or more sites.

### SUMMARY OF INVENTION

These and other objects are achieved by a system and method for estimating costs, purchasing goods , and managing resources which includes a gap analysis, a contractor locator, an estimator, an automated auction option, a procurement function and a resource manager which also enables the operation of virtual jobsite offices.

### BRIEF DESCRIPTION OF DRAWINGS

FIG. 1A is a block diagram of the system of the present invention.

FIG. 1B is a block diagram of a configuration of the present invention.

FIG. 1C is a block diagram of the present invention in a network.

FIG. 1D is a flow diagram of the overall processing of the present invention.

FIG. 2A is a flow diagram of the initial procurement and estimating features of the present invention.

FIG. 2B is a flow diagram of the gap analysis of the present invention.

FIG. 2C is a flow diagram of additional procurement functions of the present invention.

FIG. 2D is a flow diagram of the additional procurement functions of the present invention.

FIG. 3 is a flow diagram of the contractor locator of the present invention.

FIG. 4 is a flow diagram of the gap analysis of the present invention.

FIG. 5 is a block diagram of a contractor locator screen of the present invention.

FIG. 6A is a block diagram of a partial tab subhierarchy of the present invention.

FIG. 6B is a block diagram of a more detailed tab hierarchy of the present invention.

FIG. 6C is a block diagram illustrating supplier pricing.

FIG. 7 is a block diagram of an aspect of the gap analysis of the present invention.

FIG. 8 is a block diagram of an aspect of the automatic auction feature of the present invention.

FIG. 9 is a block diagram illustrating the use of the automatic auction feature of the present invention.

FIG. 10 is a block diagram of the virtual jobsite office features of the present invention.

FIG. 11 is a tree diagram of a part of the estimator labor costing features of the present invention.

FIG. 12A is a block diagram of a screen showing the selection criteria chosen by a user of the contractor locator of the present invention.

FIG. 12B is a block diagram of a screen showing the results of a contractor locator search.

FIG. 13 is a flow diagram of the selection of the auction function of the present invention.

FIG. 13A is a flow diagram showing the selection of items for auction using the present invention.

FIG. 13B is a flow diagram showing the auction search options of the present invention.

FIG. 13C-1 is a flow diagram showing an auction search by tab hierarchy of the present invention.

FIG. 13C-2 is a flow diagram showing an auction search by keyword of the present invention.

FIG. 13C-3 is a flow diagram showing the search all feature for auction searching in the present invention.

FIG. 14 is a flow diagram showing the check current auction feature of the present invention.

FIG. 15A is a flow diagram showing the initialization performed by the resource manager of the present invention.

FIG. 15B is a flow diagram showing the processing done by the resource manager of the present invention to check order status.

FIG. 16 is a flow diagram showing additional resource management options of the present invention.

FIG. 16A is a flow diagram showing the processing available to a user of the resource manager for managing resource folders of the present invention.

FIG. 16B is a flow diagram showing the job tracking features provided by the resource manager of the present invention.

FIG. 16C is a flow diagram showing the inventory management processing available in the present invention.

FIG. 17 is a block diagram illustrating price and status information a user can monitor with the present invention.

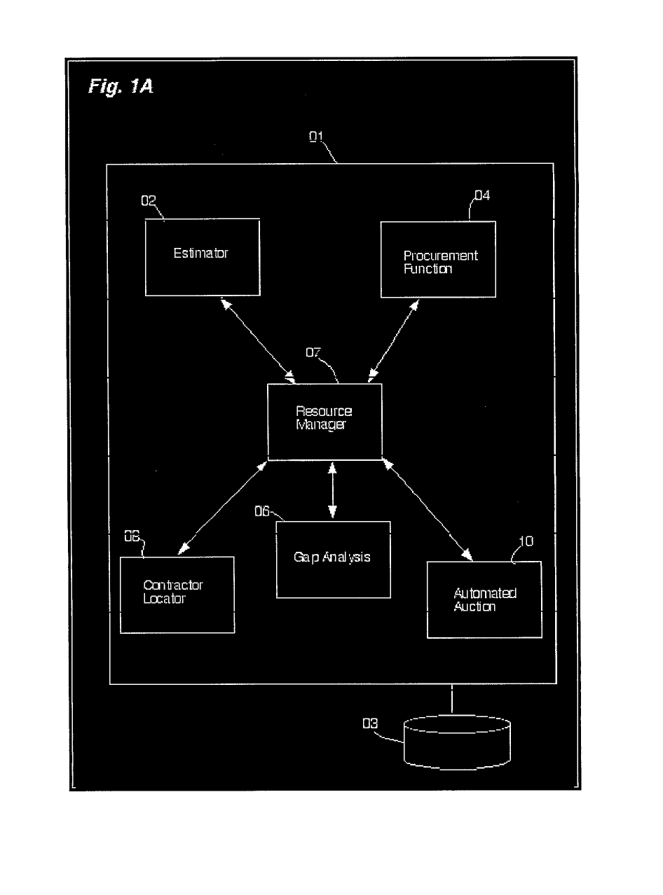

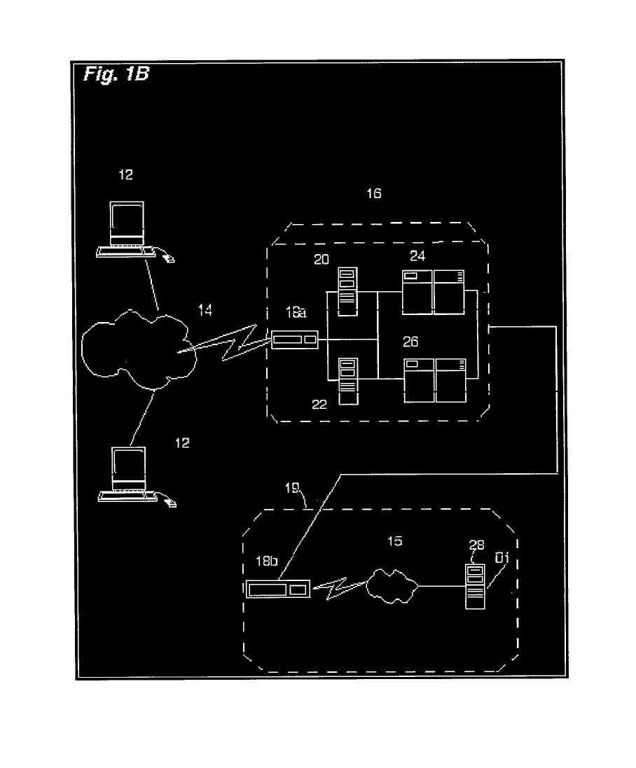

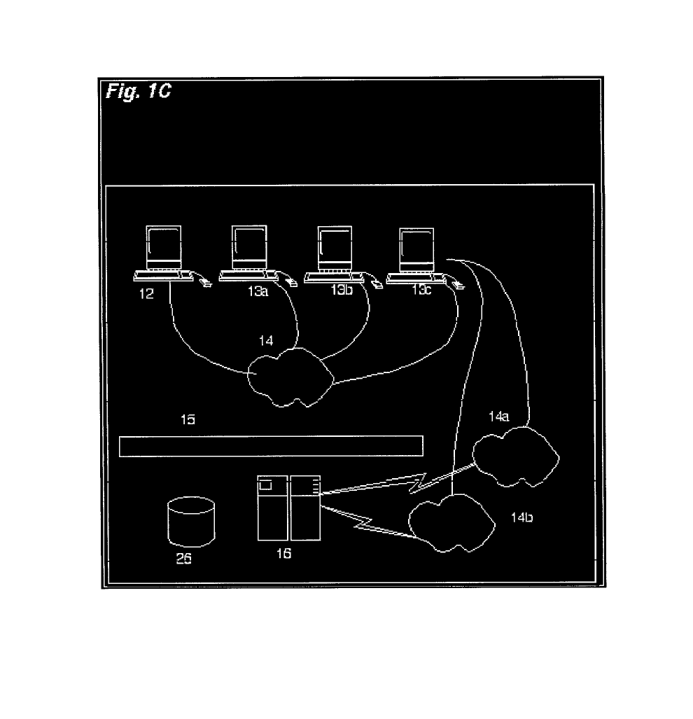

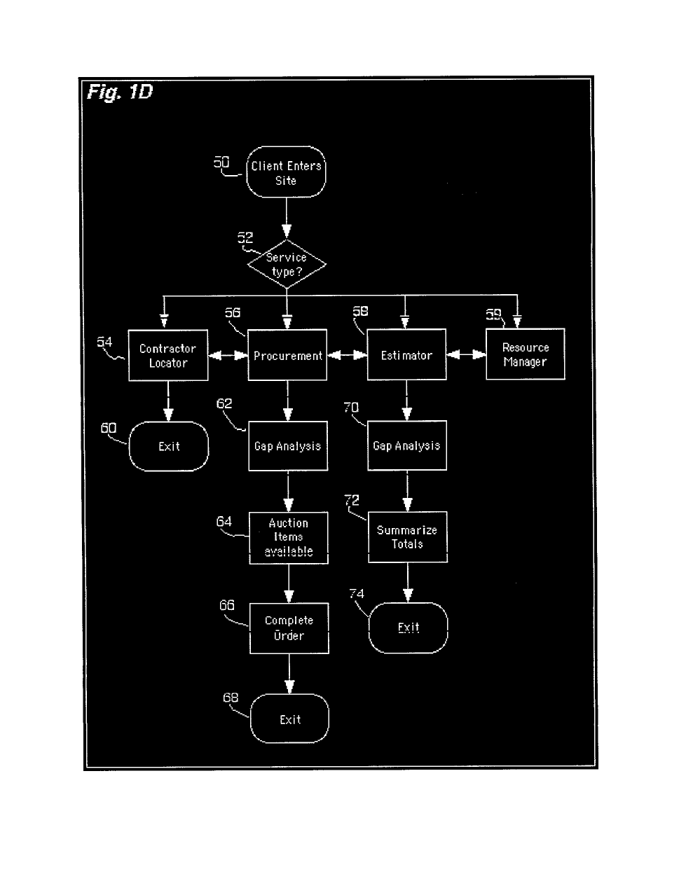

FIG. 1 iFs block diagram of typical job folders created using the present invention.

FIG. 19 is a block diagram of an illustrative equipment/rental/purchase report created using the present invention.

FIG. 20 is a flow diagram of the processing done by the present invention to create an equipment/purchase/rental report.

FIG. 21 is a block diagram of an illustrative job folder of the present invention.

FIG. 22 is a block diagram of an illustrative equipment movement report of the present invention.

FIG. 23 is a block diagram of an illustrative actual versus estimated costs analysis report of the present invention.

FIG. 24 is a block diagram of an illustrative rent versus buy analysis report of the present invention.

FIG. 25 is a block diagram of an illustrative moving ticket generated by the present invention.

FIG. 26 is a flow diagram showing the additional authorization processing done to enable the virtual jobsite office processing of the present invention.

### DETAILED DESCRIPTION

In FIG. 1A, an overview of the present invention is provided. In the embodiments shown, there are six functions in system 01 that can be used either singly or in some combinations by a general contractor or user. Estimator 02 allows a contractor to collect actual prices and component information validated for a specific building locality, in order to develop an estimate of costs for a new project. Procurement function 04 allows a contractor to order, pay for, and schedule delivery to the construction site of all the items needed for a project in a specific locality. Gap analysis 06 is used by both estimator 02 and procurement function 04 to compare the parts ordered or to be estimated with validated parts for the specific locality, thus minimizing the likelihood of ordering parts that do not meet local codes or that are not appropriate for the type of construction being built. Contractor locator 08 enables a general contractor to specify criteria for a subcontractor for a project in a specific locality and search for a match in system 01's database 03. Automated auction option 10 allows contractors to list overstock items for auction, and notifies and enables general and local contractors (or similar users) to bid on these items if they are available within a predetermined area of the target construction site. Finally, resource manager 07, integrates with the other functions and enables a contractor to schedule, move, use, and track equipment, goods, and labor at one or more sites.

Turning now to FIG. 1B, a networked configuration of the present invention is shown. Contractors 12 communicate over the Internet 14 to a service provider site 16, which operates using standard router/firewalls 18a, such as the Cisco PIX system. In turn, service provider site 16 includes front end server(s)20 and Microsoft Corporation's Internet Information server 22, which handle load balancing for one or more SQL servers 24, such as those provided by Oracle Corporation, or other SQL database providers to control access to datavault 26, which contains database 03 of the present invention. In turn, service provider 16 connects to host network 19, which provides the applications functionality for most of the present invention. As seen in FIG. 1B, host network 19 also includes a router/firewall 18b, an internal network 15, and a host data server 28 which operates system 01 as part of the website services provided by service provider 16. Those skilled in the art will appreciate that other configurations could be used to implement the present invention without deviating from the spirit thereof. Similarly, while examples are taken from the construction industry, those skilled in the art will appreciate that the present invention can also be used for other industries or applications in which complex local variations in costs and materials need to be considered. For example, the automotive industry might use some or all of the present invention for customizing local options.

FIG. 1C illustrates a configuration of system 01 in which agent terminals 13 are provided to enable human intervention by call center agents working on behalf of the host application provider.

Now turning to FIG. 1D, a flow diagram overview of the processing of the present invention is shown. As seen in this embodiment, a contractor can enter the host website at step 50, and select the type of service he or she desires at step 52. If the estimator service is selected, processing proceeds to estimator 02 at step 58, which allows the user to enter the items for which estimates are desired. As these are being entered, the invention performs a gap analysis on each item to verify that the item entered is correct for the particular system or subsystem being ordered.

For example, if 3 inch piping is being ordered and a part number for a 2 inch valve is requested, gap analysis 06 will alert the user and ask him or her to verify that this part is the one desired. In addition, gap analysis 06 also checks the part number being requested against part numbers that are validated for the zip code (or other postal code) of the target construction site. Thus, if PVC piping or other requested material is not permitted by local building codes, gap analysis 06 will detect this and alert the user to that fact at step 70 of FIG. 1D. More detail on gap analysis 06 is provided below. In the embodiments shown, the automated auction option is not used automatically by estimator 02, since a contractor in the estimating stage of a project may not want to commit to purchasing or bidding on any materials if the project has not been awarded to that contractor. However, in the embodiments shown, a contractor is free to use the auction feature through resource manager 07, if the contractor wishes to do so.

Still in FIG. 1D, estimator 02 summarizes the totals for the items requested at step 72 and displays the results to the user, before exiting at step 74. In the embodiments shown of the present invention, at this point the user has an estimate that is based on actual local prices for the designated zip code, as discounted for that locale, together with the assurance that the items requested have been checked against local building codes and for internal consistency, thus significantly lowering the risk of using the wrong items and prices in the estimate.

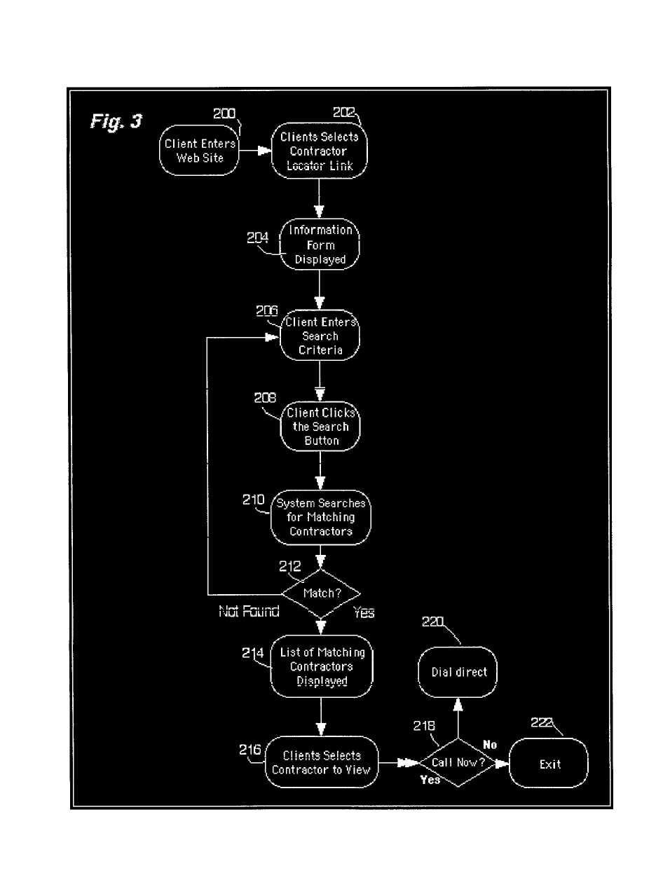

At this point, if the user is a general contractor, he or she may want to use contractor locator 08 of the present invention to screen potential subcontractors in the area. Turning now to FIG. 3, a flow diagram of contractor locator 08 of the present invention is shown. At step 200, the client enters the web site and at step 202 selects the contractor locator link. At step 204 the invention displays locator information form 09 (as seen in FIG. 5) for the client, to allow the client, at step 206 of FIG. 3 to enter search criteria. Those skilled in the art will appreciate that the search criteria can be modified to meet the user's requirements and to take experience with the system into account. Similarly, while the examples shown in these embodiments illustrate search criteria for contractors in the construction industry, those skilled in the art will appreciate that similar criteria can be developed for other industries.

As seen in FIG. 5, locator information form 09 allows a user to select from a number of search criteria. In the embodiments shown, a user is invited to select from up to five SIC codes for a contractor, in box 9a of locator information form 09, and up to five zip codes in box 9b of locator information form 09. In addition, if the user wishes to do so, the user can select from additional criteria such as those illustrated in boxes 9c and 9d. For other industries, different criteria could be used.

Returning to FIG. 3, once the search criteria have been entered, the client clicks the search button at step 208, and at step 210, the system searches for contractors who match those criteria. At decision block 212, the invention checks to see if there is a match, and if not, the client is allowed to modify or enter new search criteria at step 206 again. If there is one or more match, a list of matching contractors is compiled for display at step 214. At step 216, the client can select a contractor to view. If the client is at a computer terminal or location capable of receiving and sending voice telephony, the system at step 218 can offer the client the option to call the contractor now and speak with him or her directly. If the client prefers not to do this, the client can exit from contractor locator 08 at step 222.

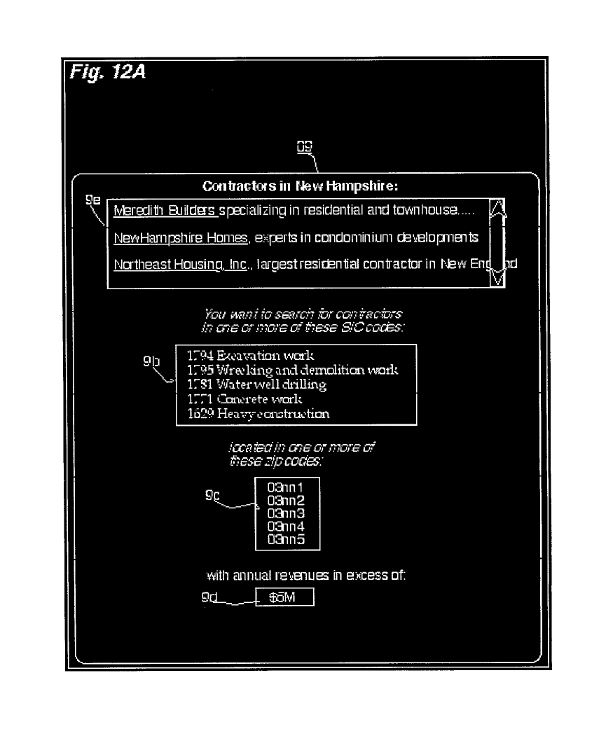

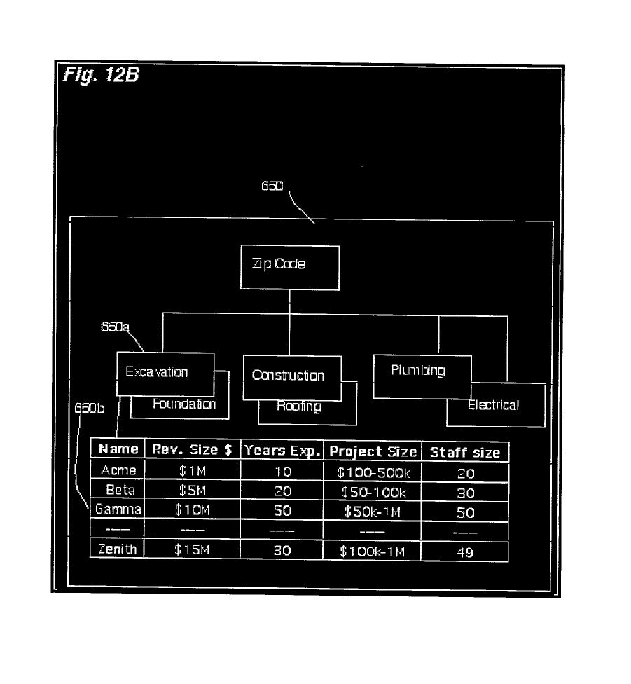

FIG. 12A shows how the confirmation screen for locator information form 09 might appear for a request to find excavation contractors in the Lakes region area of New Hampshire. Note also that banner 9e in FIG. 12A already contains an automatically scrolling list of subscribing contractors in that area that the user might wish to check out in addition to the ones found by the search. In the embodiments shown, such a banner would automatically rotate through an entire list of subscribed contractors so that each would get approximately equal visibility when such a relevant screen comes up. That is, in this example, contractors with names starting with the letter M appear, but the next time such a screen arises for this user, contractors from another section of the list would appear.

Turning briefly to FIG. 12B, if the general contractor is looking for a potential subcontractor in the target location who has significant experience in excavation, criteria tree 650 would be used for the designated zip code(s). As seen in FIG. 12B, subcontractors in that location who provide excavation services 650a range in size from those with a staff of 20 and annual revenues of one million dollars, to those with annual revenues in the ten to fifteen million dollar range and larger staffs. In the example shown, the years of experience each has are included as are the types of projects by dollar size that each typically works on. From this it can be seen that subcontractor Gamma 650b has the most experience and works on the broadest range of project sizes. Subcontractor Gamma 650b also meets the search requirements and would be one of those returned by the search request outlined above of the user. Those skilled in the art will appreciate that other criteria could be used without deviating from the spirit of the invention.

Returning now to FIG. 1D, if the general contractor has been awarded the contract to proceed with the work, it might use procurement function 04 to begin acquiring the materials needed for the work. At step 56, the user would enter the items needed for the project. In the embodiments shown, procurement function 04 automatically uses gap analysis 06 to verify that each item purchased is validated for the local building codes (or whatever local requirements apply for other industries), and is internally consistent with the rest of the order that is, a 2 inch valve should not be inadvertently ordered for a 3 inch pipe system unless there is some special exception the user has in mind. In the embodiments shown, the user is notified of inconsistencies and given the option to consciously choose them, if that is the case.

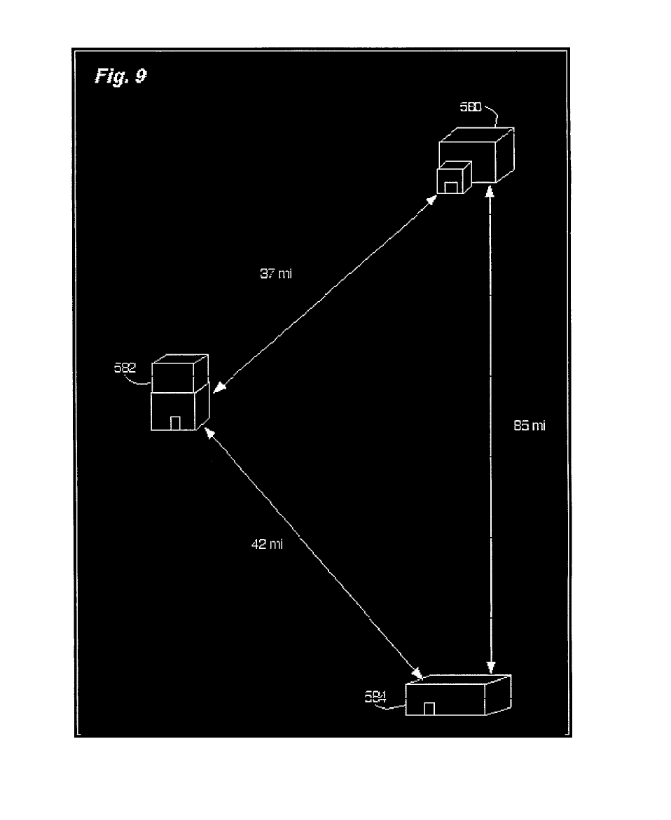

Still in FIG. 1D, procurement function 04 uses automated auction option 10 to see if any of the parts being ordered are available at lower prices through auctions in the area near the target location. Turning briefly to FIG. 9, subcontractors working at construction locations 580,582 and 584 may have overstock they have placed for auction through the system. For example, the subcontractor working at construction location 582 may have some PVC water piping in overstock that can no longer be used in the municipality where subcontractor 582 is located. If a general contractor is using the procurement function 04 of the present invention for a site within a fifty mile radius of construction location 582, procurement function 04 will automatically check to see if any of the parts ordered by the general contractor are available for auction in that fifty mile radius. Thus, if the general contractor is ordering for construction location 584, which is 42 miles from construction site 582, any items that were placed for auction by the subcontractor at construction location 582 would be considered.

Turning briefly to FIG. 8, the subcontractor at location 582 might be Meredith Building in zip code 03253. Using the automated auction option 10 of the present invention, that subcontractor has put some 3 inch PVC water pipe up for auction with a minimum sale price for each. If PVC water piping is acceptable in construction location 584 (as determined by gap analysis 06), then automated auction option 10 enables the general contractor to place a bid for those materials during the procurement process. If the general contractor needs 500 units of PVC 3 inch water piping part number PND, and the discounted purchase price for new items is $75 per unit, the general contractor may be able to make substantial savings by buying 99 of those units at auction.

In the embodiments shown, the automated auction option 10 checks for such items within a specified mile radius of the target construction site, to minimize the need for additional transportation costs. For example, a subcontractor on the west coast may have hundreds of units available for auction, but the cost of transporting them to the east coast, and the potential delays in packing and shipping may negate any cost savings. However, most contractors can have their local crews pick up materials within a reasonable local radius, such as forty or fifty or even a hundred miles, without incurring too much additional expense in doing so. In the embodiments shown, a fifty mile radius has been selected, but those skilled in the art will appreciate that this can be varied depending on the industry needs or experiential data. In an alternative embodiment, the user can select the value for the mileage radius for automated auction option 10. In another embodiment, the user eliminate any specified radius and simple check to see if the item is on auction anywhere known to the system.

Still in FIG. 9, the present invention associates a latitude and longitude with each zip code, to enable automated auction option 10 to calculate the direct distance between two locations.

Returning to FIG. 1D, at step 64 any items bought at auction are made available to the system and procurement function 04 proceeds to step 66 to complete the order. As will be seen in more detail below, this includes paying for the goods, scheduling shipments and coordinating delivery to the site by a delivery handler.

Still in FIG. 1D, it can be seen that a user can also initiate use of resource manager 07 from the website at step 59. As will be described in more detail below, resource manager 07 allows a contractor or subcontractor to allocate equipment, goods and crew to a project, schedule their use, track the costs of the use, and reserve them for future projects, among other tasks.

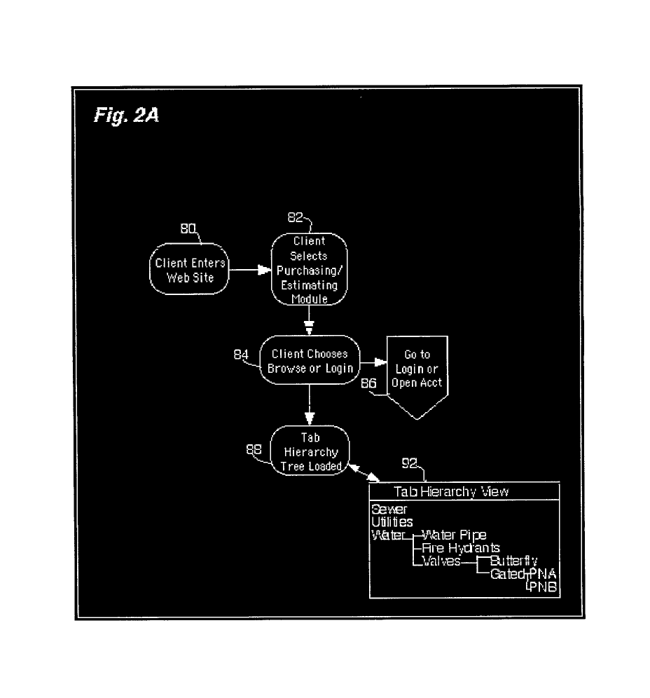

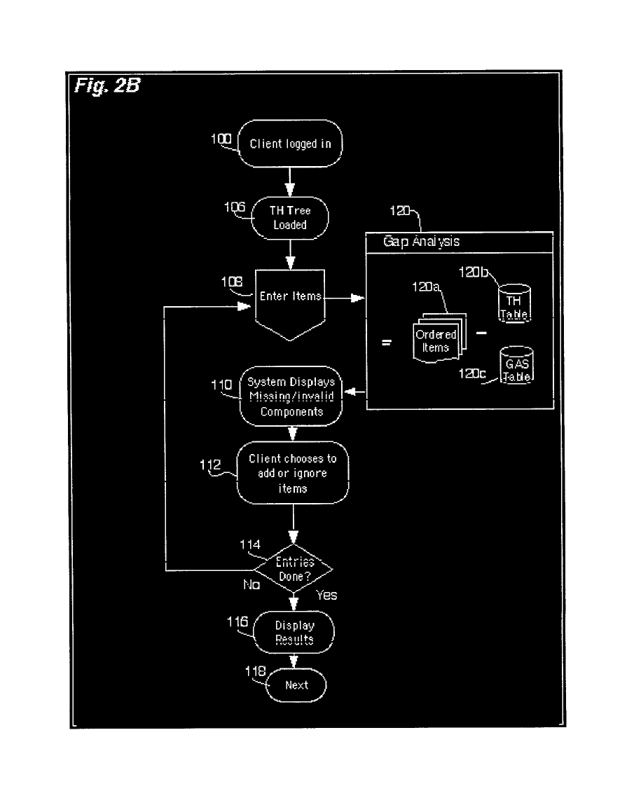

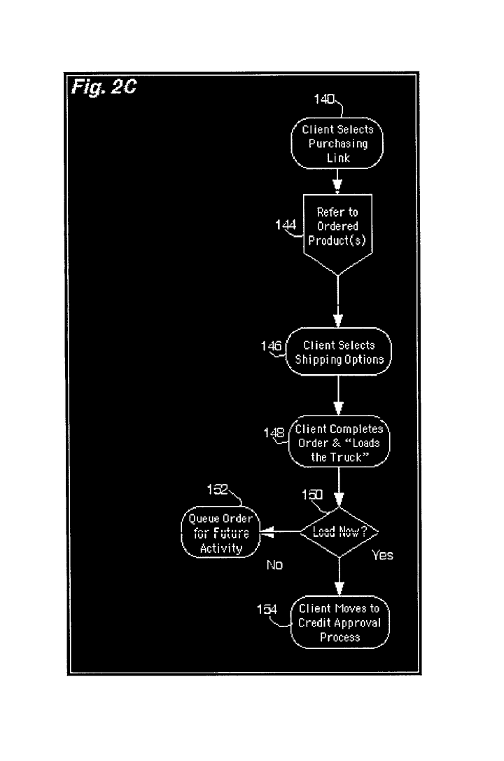

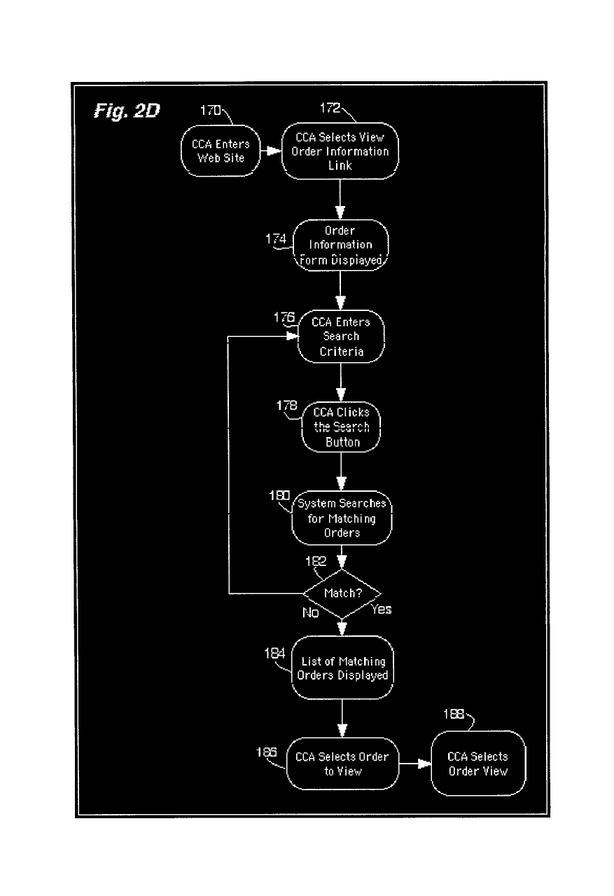

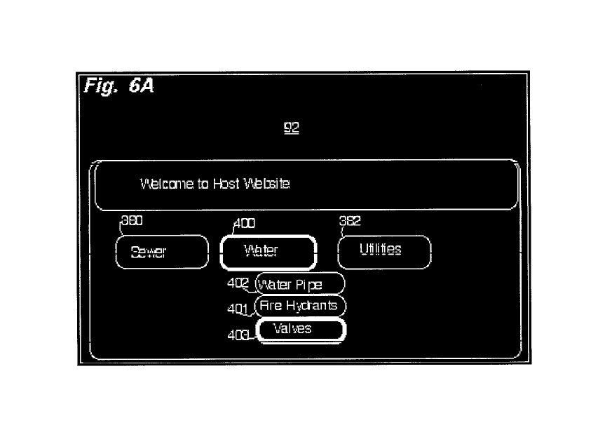

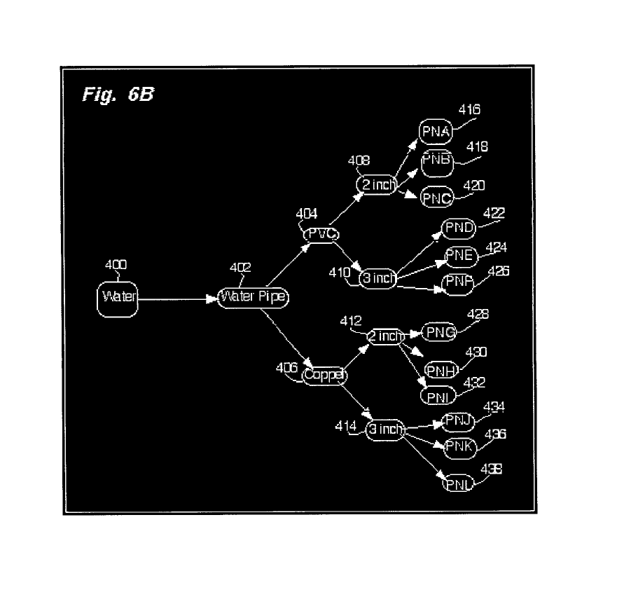

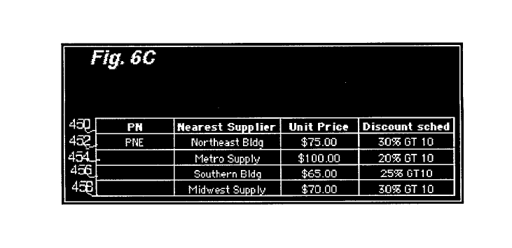

Turning now to FIG. 2A, a flow diagram of the initialization of both procurement function 04 and estimator 02 is shown. At step 80, the client enters the website and at step 82 selects either procurement function 04 or estimator 02. In the embodiment shown, the client may elect just to browse the site at step 84 or to log in or open an account at step 86. In either case, tab hierarchy tree 92 is loaded at step 88. In the present invention tab hierarchy tree 92 uses conventional tab structures on a website, as illustrated at FIG. 6A and 6B. In FIG. 6A, when the tab hierarchy 92 has been loaded and displayed on the host website, an individual screen might appear as shown, with tabs or buttons for sewer 380, water 400 or utilities 382. If the client clicks on water 400, another tree structure is made available such as that shown in FIG. 6B, which shows a simplified tree structure for water pipe systems 402.

Referring next to FIG. 2B, at step 100 a client has logged in to use either procurement function 04 or estimator 02 and the tab hierarchy tree 92 has been loaded at step 106. At step 108 the client enters an item to be purchased (or for estimating) by following tab hierarchy 92 to the appropriate systems and then part numbers. At step 120 gap analysis 06 takes place, as will be described in more detail below. As a result of gap analysis 06 the invention displays any missing or invalid components at step 110 and at step 112, gives the client the option to choose to add or ignore the correct items. At step 114, the invention checks to see if the client has completed all entries. If it has, the results are displayed at step 116, and stored and the invention proceeds at step 18 either to summarizing the estimates and providing reports or to continuing a procurement transaction. If the client has not completed entries, the invention loops back to step 108.

Now referring to FIG. 2C, if the client has selected procurement function 04 at step 140, the invention refers to the stored list of ordered products at step 144. Next, at step 146, the clients selects from the conventional shipping options provided and proceeds to step 148 to complete the order and “load the truck” or request deferred delivery. At step 150 the invention checks to see if immediate loading has been requested, and if it has, proceeds to the credit approval process at step 154. If deferred delivery has been requested, the order is queued at step 152 for future activity.

An additional feature of procurement function 04 is that the host website can also support human call center agents (CCA) who can check on transactions for clients and verify processing as shown in FIG. 2D. As seen there, if a client calls with a question about the status of an order, the CCA can enter the website at step 170, select the view order information link at step 172, and the system displays the general order information. At step 176, the CCA can enter search criteria for the order and click the search button at step 178. Using conventional search technology, the present invention searches for a one or more matching orders at step 180. As matches are found at step 182, they are displayed, and searching continues until a list of all matching orders is displayed at step 184. At that point the CCA can select the particular client order to view, at steps 186 and 188.

An additional feature of estimator 02 is that labor cost estimates by phase of a project can be factored in by the client though the estimator's phase labor calculator, using locality specific labor averages by phase, such as those shown in FIG. 11. As can be seen there, the present invention stores by type of construction and phase, average hourly labor costs for different classes of laborers in the target zip code. For example, in Phase I, an equipment operator is likely to be one who works on heavy equipment, and thus is more likely to have a higher hourly rate than equipment operators working in the other phases.

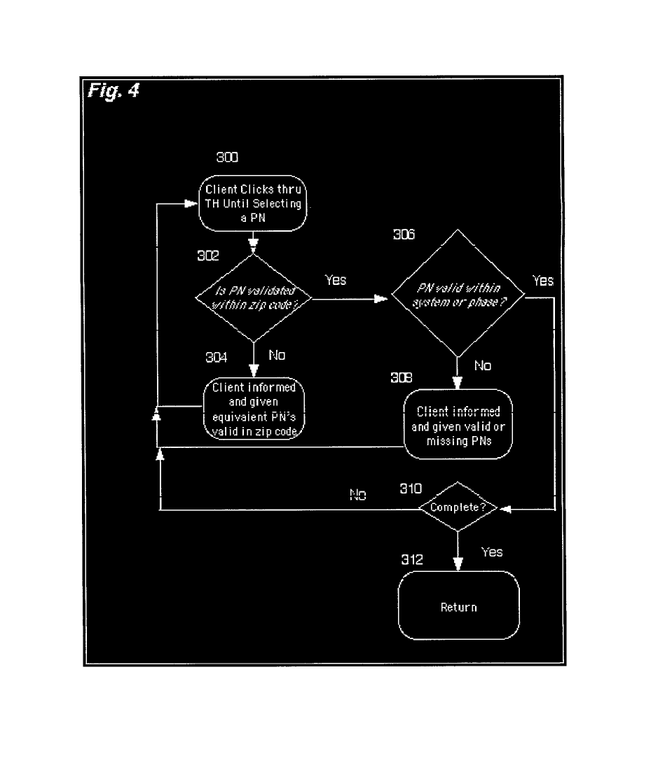

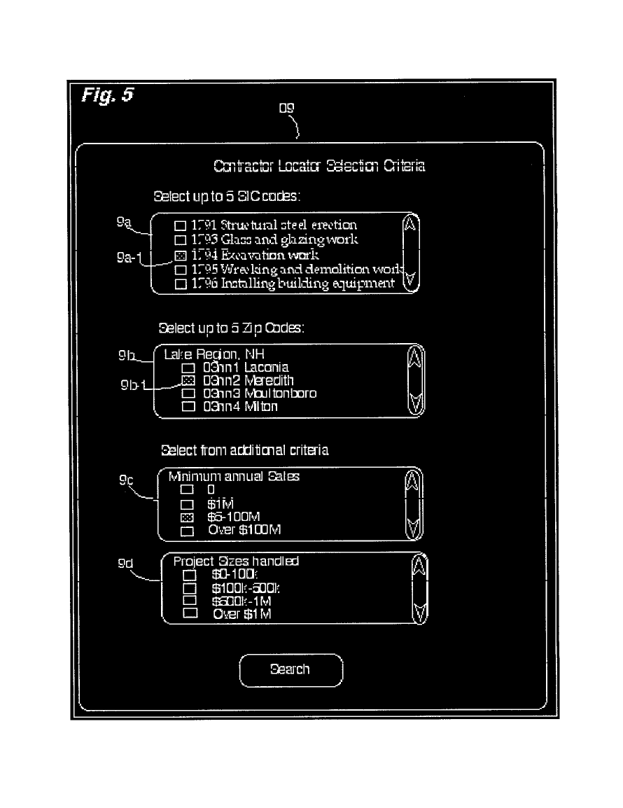

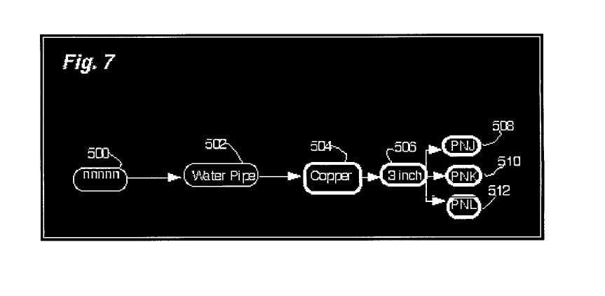

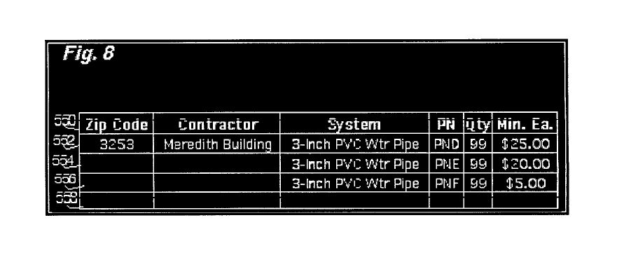

With reference now to FIG. 4, a more detailed flow diagram of gap analysis 06 is given. In the embodiment shown, when the client has selected a part number PN at step 300, the invention checks at step 302 to see if that part number PN is valid within the zip code entered for the target construction location. Note that a zip code or similar geographic identifier must be entered for this feature. Referring briefly to FIG. 6B, a subhierarchy of the tab hierarchy for water related parts is shown, having part numbers for PVC water pipes in 2 and 3 inch sizes as well as part numbers for copper water pipes in 2 and 3 inch sizes. If the client has selected part numbers PN PNA through PNC for 2 inch PVC piping, the present invention will check those part numbers against valid part numbers for the target location. Referring now to FIG. 7, an example of a validated parts list in database 03 for zip code 500 is shown. In this example, only 3 inch copper pipes are valid for the building codes in this zip code.

Returning now to FIG. 4, the invention will so inform the client at step 304 and provide the client with the equivalent part numbers that are valid for this zip code (in this case part numbers PNJ-PNL. If the client selects these at step 300, they will be validated at step 302 and an additional integrity check is made at step 306 for internal consistency. Here, the part number is checked to see if it is valid within this subsystem. For example, if the client has been ordering parts for a 3 inch water system and inadvertently enters a part number for a 2 inch system, the present invention will inform the client of the discrepancy at step 308. Similarly, if the client has ordered 3 out of 4 parts typically used in a 3 inch water pipe system, but has not ordered the fourth part, the present invention will note the missing part number at step 308 and allow the client to enter it at step 300, if the client so chooses. Additionally, if the requested item is a service in a phase of a project, at step 306 the phase labor calculator verifies that the requested item number is valid for this phase, and if not, suggests one that is. Finally, at step 310, the invention checks to see if the client has completed the order and if it has, the gap analysis returns, at step 312 to the appropriate procurement function 04 module or estimator 02 module.

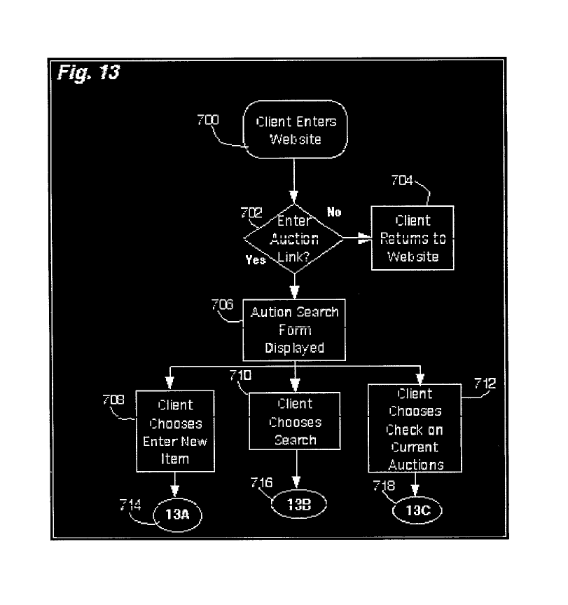

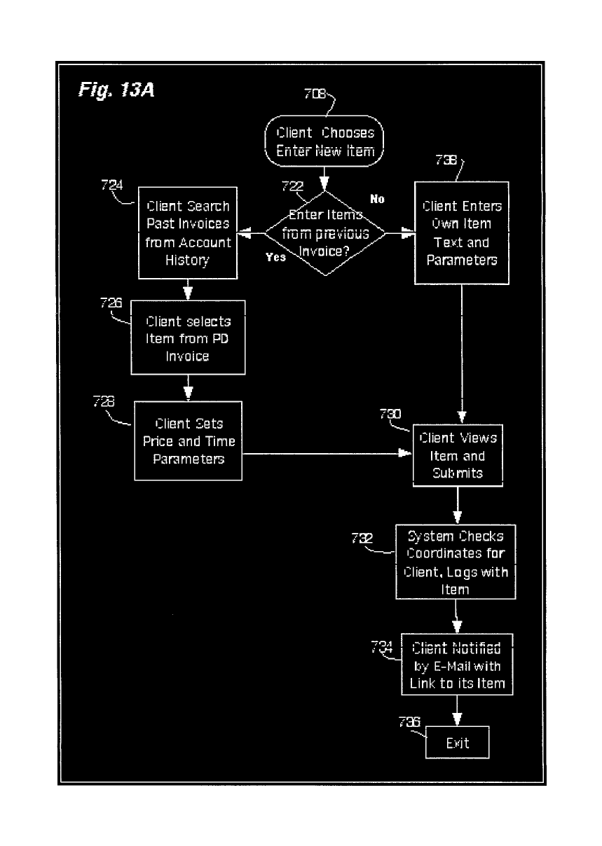

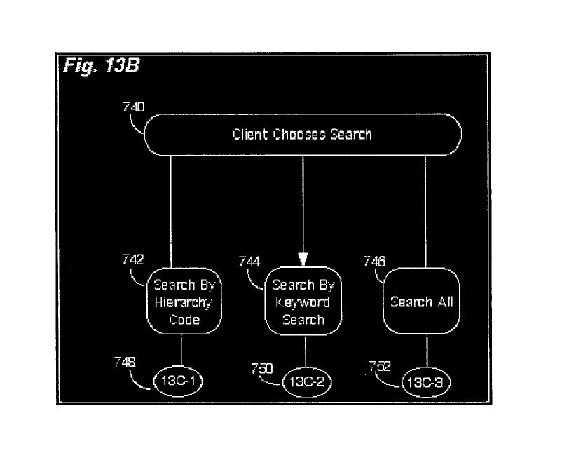

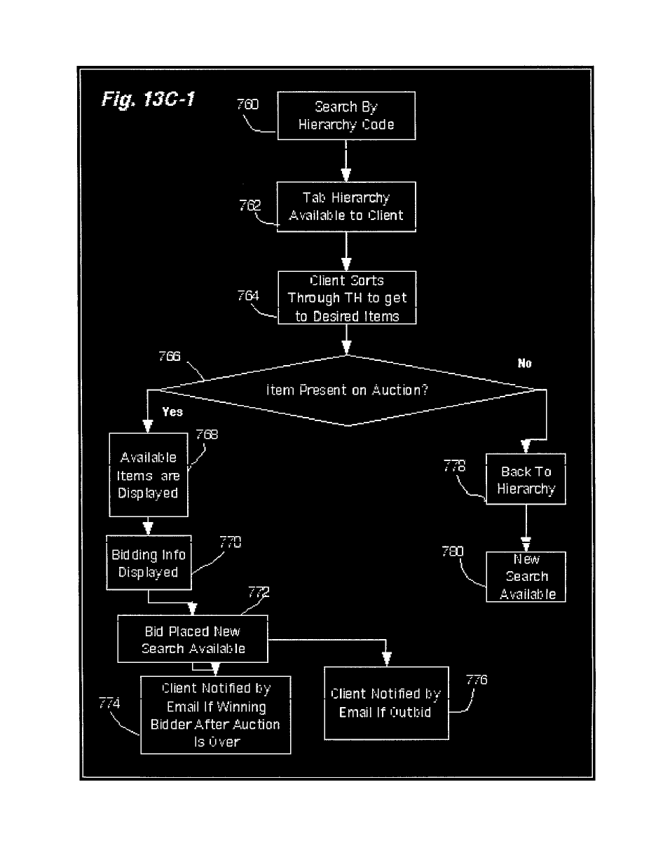

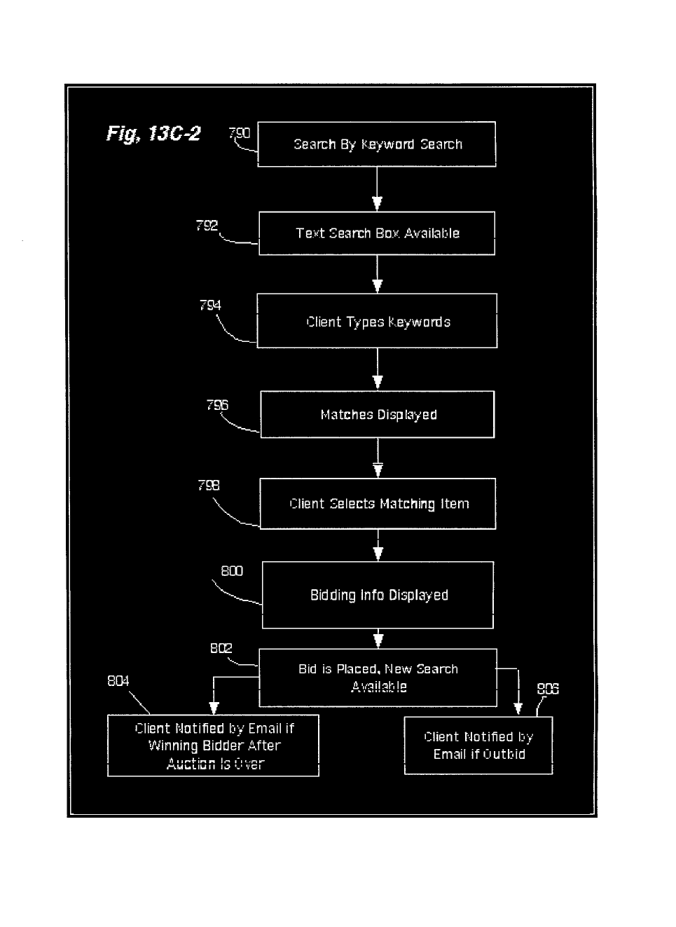

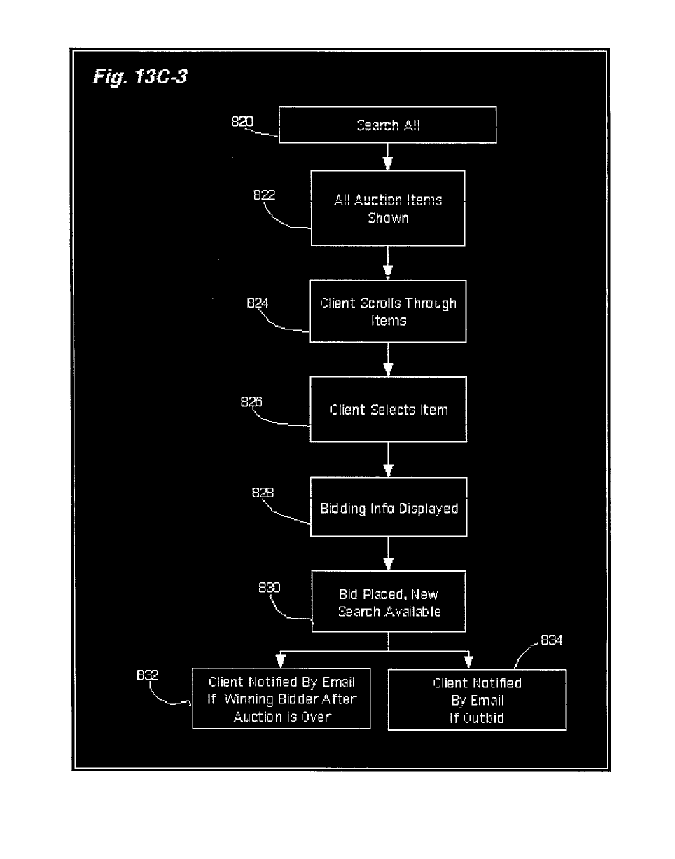

With reference now to FIG. 13, more detailed flow diagrams of automated auction option 10 are shown. In FIG. 13, a client contractor may enter the website at step 700 as a result of an earlier notification or simply to check the auction features. At step 702, system 01 checks to see if the client wishes to enter the auction link. If it does, processing proceeds to step 706. If not, the client returns to the website homepage at step 704.

Still in FIG. 13, if the client wants to enter the auction link, an auction search form is displayed at step 706. In the embodiments shown, this is a conventional web page window offering links or buttons that allow the client to enter a new item, as seen at step 708, or to choose to search at step 710, or to choose to check on current auctions at step 712. For entering a new item, processing proceeds to FIG. 13A.

In FIG. 13A, for entering a new item system 01 checks at decision block 722 to see if the client wants to enter items for auction from a previous invoice already in the system. If yes, processing proceeds to step 724. If not, the client enters a new item at step 738 and proceeds to step 730.

Still in FIG. 13A, a feature of automated auction option 10 of the present invention is that it allows a contractor client to search its past invoices from the account history for that contractor maintained by resource manager 07. The search is done at step 724, and at 726, the client selects an item from the prior invoice to submit for auction. At step 728, the client sets the price and time parameters it wants to use for the auction. In the embodiments shown, the price set at this step is taken as a minimum bid or reserve, by automated auction option 10, and bid increments are determined by the current bid value. For example, current bids between $1-10 increment at 50 cents, while current bids at $10-$50 increment by a dollar, and so on. At step 730, automated auction option 10 allows the client to view the item and submit it for auction. At step 732, automated auction option 10 checks the longitude and latitude coordinates for this client's location and logs those with the item submitted for auction, so that the appropriate radii can be calculated. Next, at step 734, the client is notified by e-mail or similar notification functions, with a link to the item. Finally, processing for this exits at step 736.

Turning now to FIG. 13B, if a client wants to see if a particular item is available for auction and has selected the search option, automated auction option 10 checks at step 742, to see if the client wants to search by hierarchy code, at step 744 to see if a keyword search is desired, or at step 746 to see if search all was selected.

Searching by hierarchy code is shown in FIG. 13C-1, beginning at step 760. At step 762, the tab hierarchy described above, is made available to the client. At step 764 the client sorts through the tab hierarchy by clicking on the appropriate tabs to get to the desired items. Once a desired item is selected in step 764, automated auction option 10 checks at step 766 to see if the selected item is presently on auction. If it is not, the client goes back to the hierarchy at step 78 and to a new search at 780, if desired.

Still in FIG. 13C-1, if the selected item(s) are on auction, the available items are displayed at step 768 and bidding information about them is displayed at step 770. At step 772, the client is given the opportunity to place a bid or select a new search. If a bid is placed, and the client ultimately is the winning bidder, the client is notified at step 774 by e-mail once the auction is over. If the client places a bid and is outbid while the auction is still running, the client is notified at step 776 if the client has been outbid.

In FIG. 13C-2, searching is done by keywords, at steps 790-802, and the same notifications are available at steps 804 and 806 if the client is the winner or is outbid.

FIG. 13C-3 shows the processing used at steps 820 through 834, if the client wants to search through all the auction items to select items on which to submit bids.

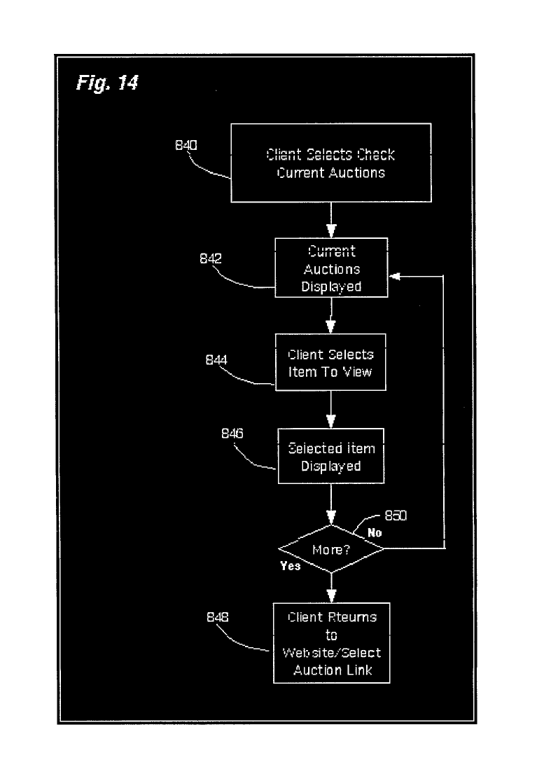

In FIG. 14, a client can enter the website at any time to check on current auctions at step 840. The current auctions are displayed at step 842, and the client can select one or more to view at step 844. This process can repeat at steps 846, 850 until the client chooses to return to the website home page or select auction link at step 848.

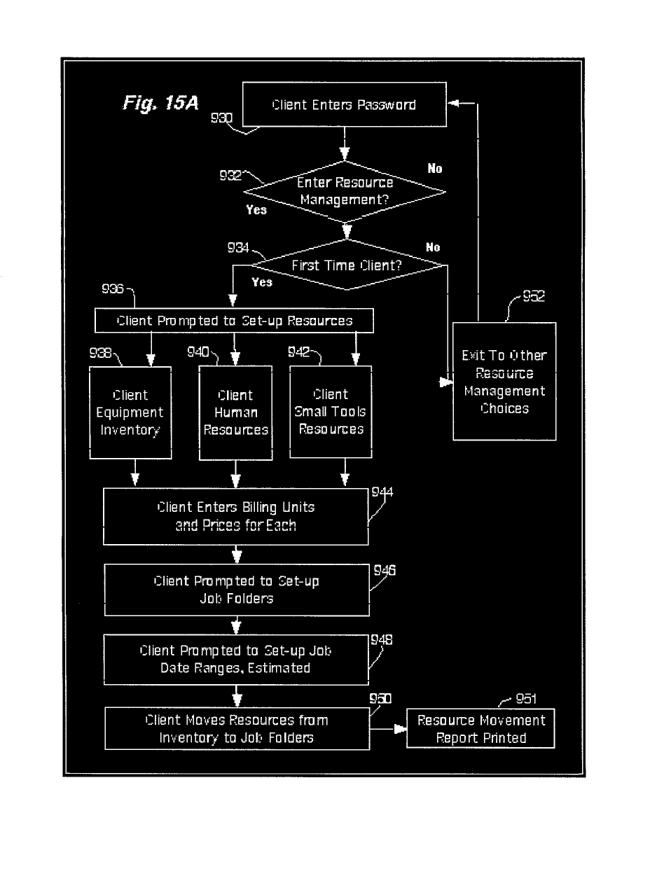

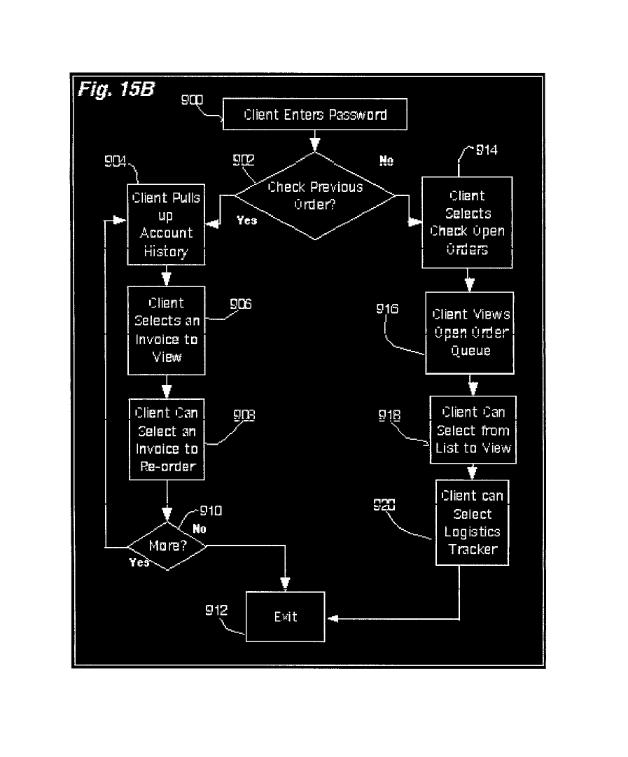

Now turning to FIG. 15A, initial processing of resource manager 07 is shown. At step 930, the client enters its password and at step 932, resource manager 07 checks to see if the client intends to enter resource management. If not, processing returns. If the client does want resource management, resource manager 07 checks at step 934 to see if this is the first time the client has used the system. If not, other resource management choices are offered at step 952.

Still in FIG. 15A, if this is the first time the client has entered resource manager 07, at step 936 the client is prompted to set up resources. At step 938, for example, the client organizes an equipment inventory, at step 940 a human resources “inventory”, and at step 942, small tools inventory. In the embodiments shown, the system automatically creates a purchased goods inventory as items are purchased through procurement function 04. Material so purchased automatically updates into a purchased goods inventory at the time of invoicing, as long as the client has tagged the goods with the same name as the jobname in the client's job folders. Depending on the nature of the client, other types of resource inventories could be created.

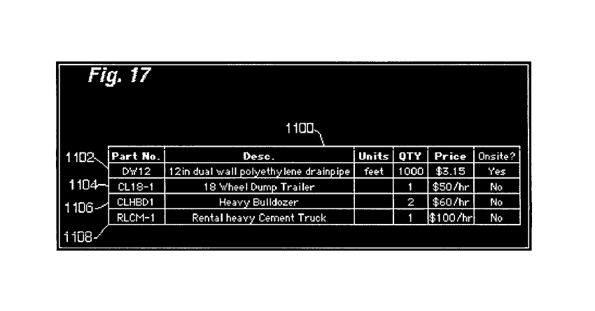

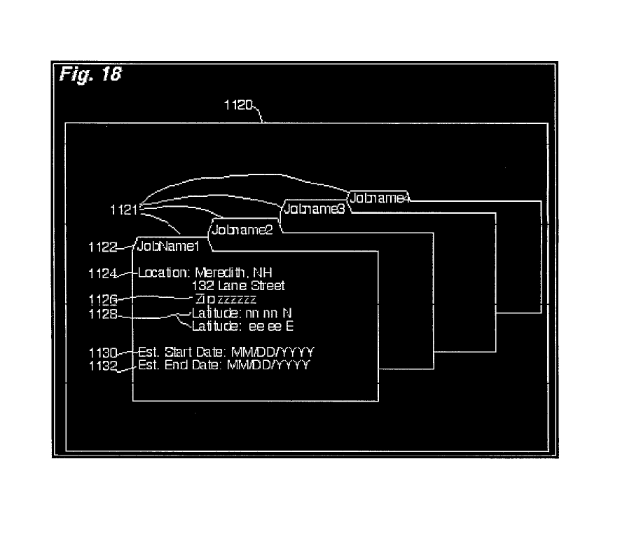

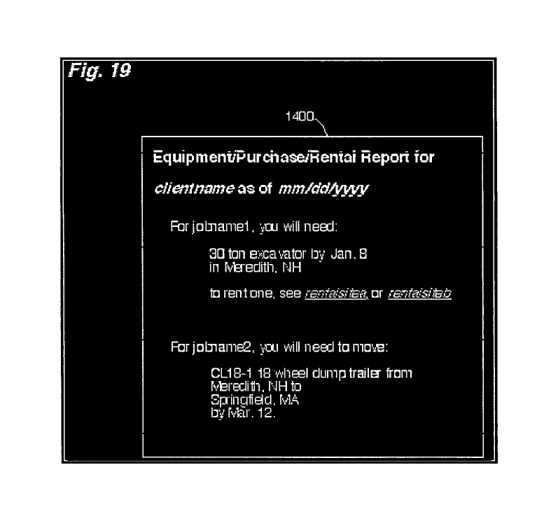

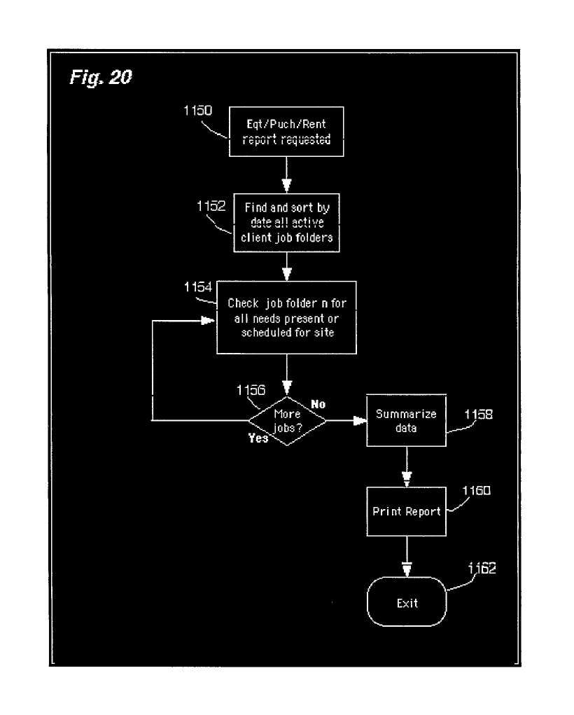

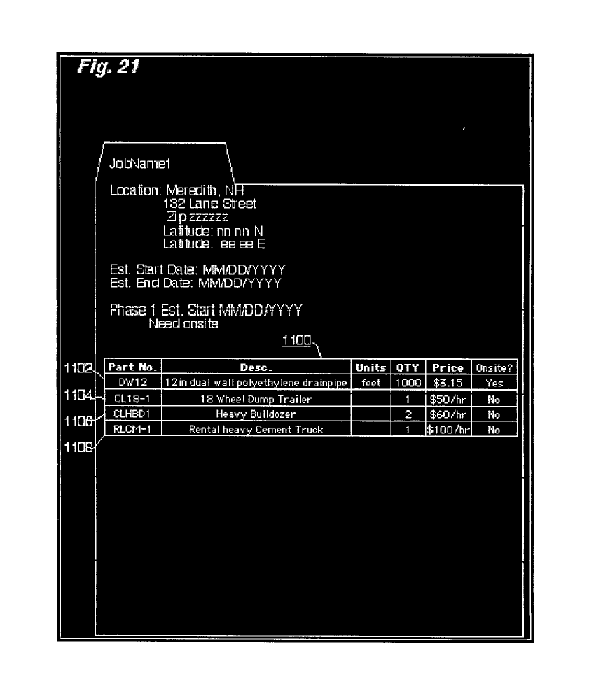

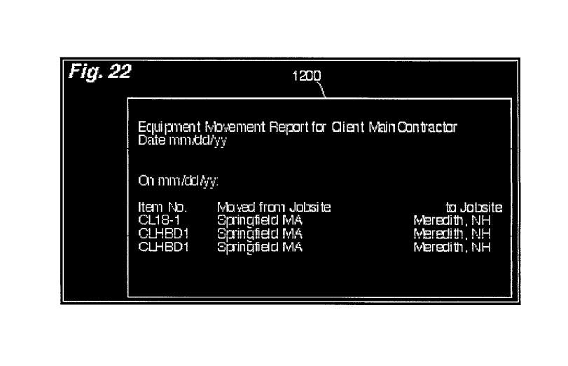

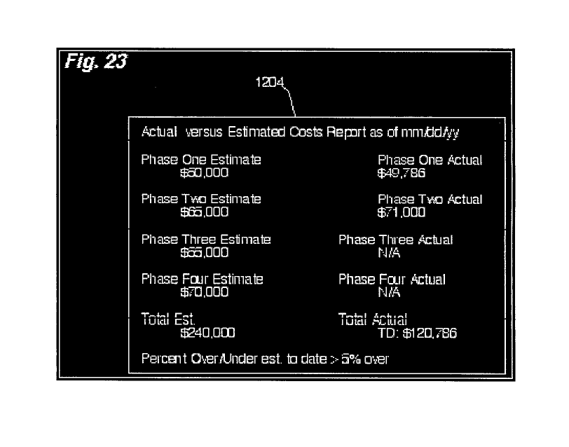

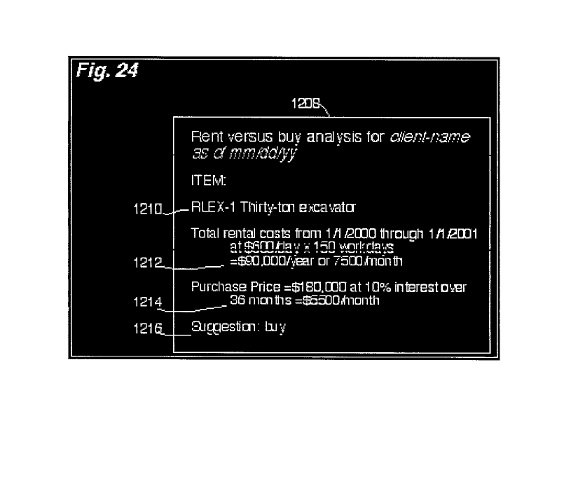

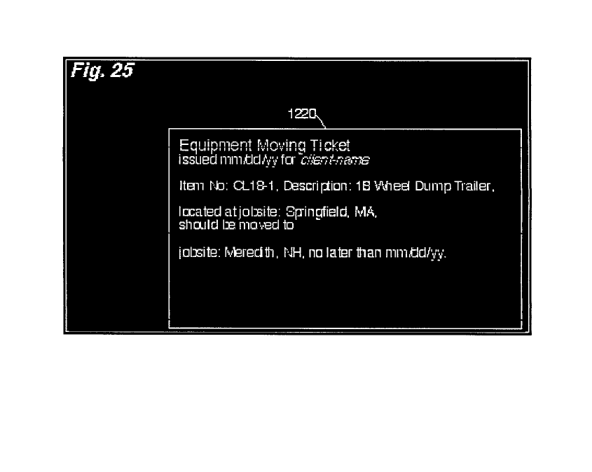

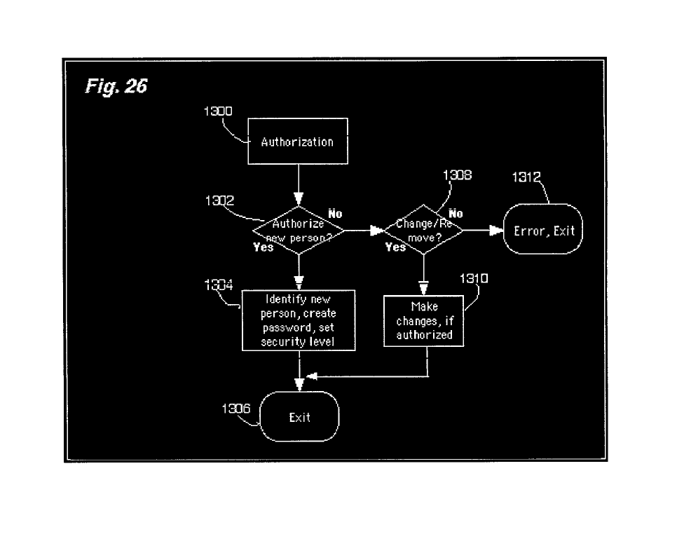

Still in FIG. 15A, at step 944, the client enters billing units and prices for each of the items in an inventory. Turning briefly to FIG. 17, examples are shown in table 1100. As seen at entry 1102, purchased items such as part number DW12, can be entered as well as client owned items, such as part number CL18. Once these have been entered and returning to FIG. 15A, resource manage 07 uses this information to track and analyze resource usage. Next, at step 946, resource manager 07 prompts the first time client to set up job folders for each of the jobs the client desires to address. Then, for each job folder, resource manager 07 prompts the client to set up job date ranges and estimates.

Turning briefly to FIG. 18, at screen 1120, sample job folders 1121 are shown, with the first having a jobname 1122 of jobname1. This job is scheduled to be done at location 1124. Taking the zip code 1126 from that location, resource manager 07 has already converted the zip code 1126 from that job site into coordinates 1128 which can be used by automated auction option 10 for calculating distances for the auction option.

Returning now to FIG. 15A, once the folders have been set up and initialized, the client at step 948, can move resources from inventory to the appropriate job folders. For example, if the client has heavy earth moving equipment in the Springfield, Mass. area that is needed for a job on January first in Meredith, N.H., the client would by now have created a job folder for the Meredith job, and can now move the heavy equipment to that folder at step 950. Once there has been a move, resource manager 07 will prompt the client to decide whether a resource movement report should be printed at step 951, and if the answer is yes, it will be printed.

Referring now to FIG. 15B, resource manager 07 enables a client to review orders placed through procurement function 04. At step 900, the client enters its password, and resource manager 07 checks at step 902 to see if the client wants to check a previous order or check on open orders. If previous orders are selected, resource manager 07 pulls up the client's account history at step 904, and at step 906, the client can select an invoice to view. At the client's option, at step 908, the client can select an invoice to use as the basis for a reorder and submit it. At step 910, resource manager 07 checks to see if the client wishes to review more, and if yes, returns to step 904. If no, any re-orders are processed and resource manager exits at step 912. If the client had selected a review of open orders at step 914, resource manager 07 shows the client its open order queue at step 916. At step 918, the client can select from the list and view one or more orders.

If desired, at step 920, the client can also select the logistics tracker to see where the order is. In the embodiments shown, resource manager 07 uses its own internal tracking to keep track of customer inventory moved from folder to folder. For items purchased through the procurement function 04, the embodiments shown use a structured query language (SQL) product called NextThere™ by NextThere Corporation, which uses global positioning satellite (GPS) technology to track vehicles carrying items purchased through procurement function 04 with an accuracy level that is usually only twenty minutes behind realtime. Thus, if a vehicle tracking report says a delivery truck arrived in Springfield Mass. at 10 am, the accuracy of the overall system is such that the truck probably arrived there at 9:40 am. Thus, it can be seen that resource manager 07's ability to integrate procurement, tracking, and scheduling provides powerful monitoring and control information to the user.

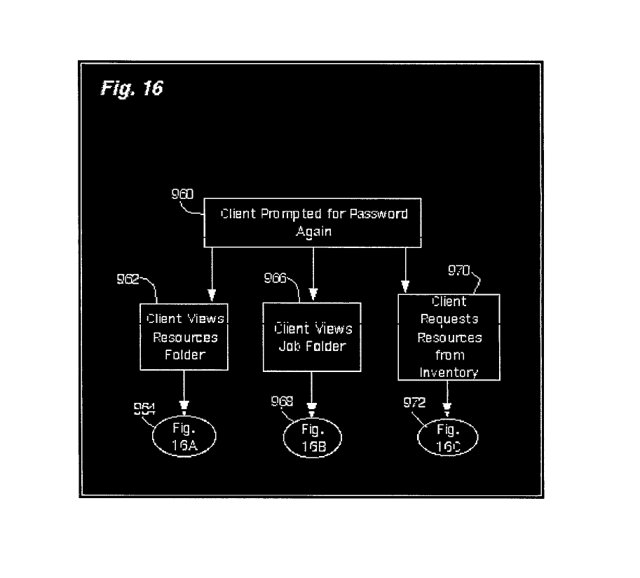

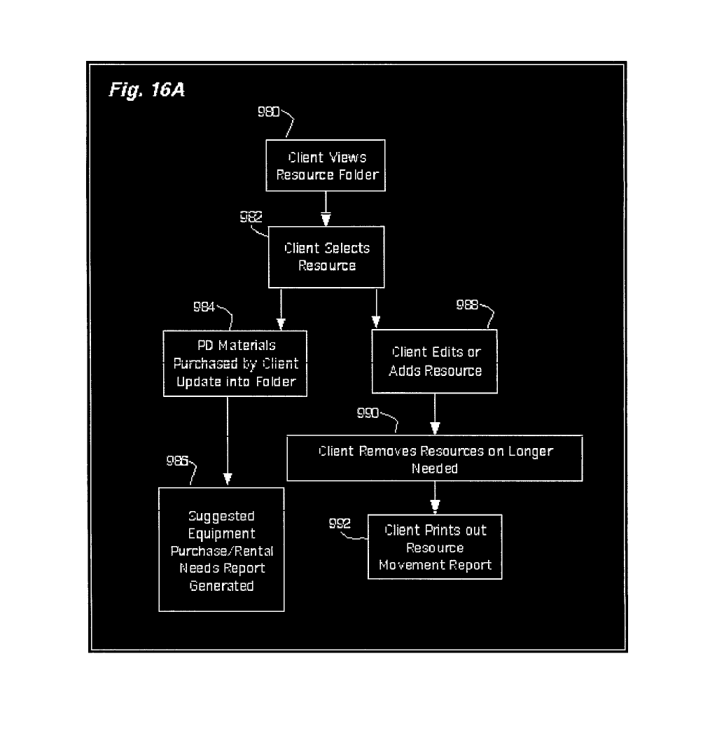

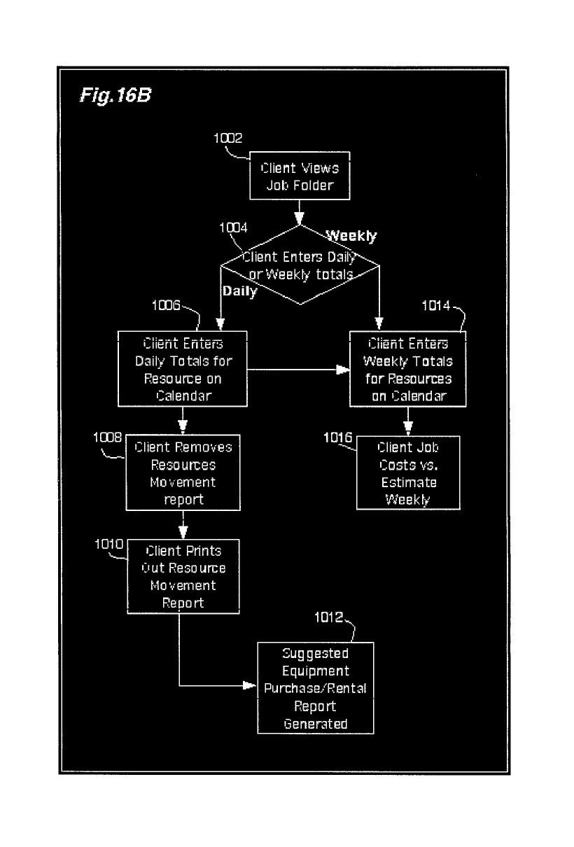

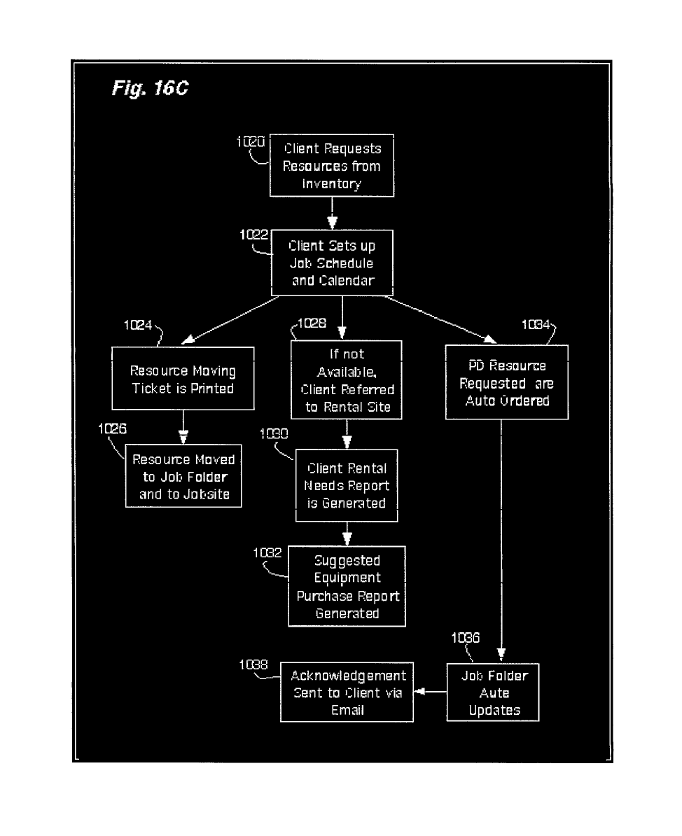

Now in FIG. 16, once a client has initialized its resource and job folders, it can enter resource manager 07 at any time as seen in FIG. 16, by entering a password and selecting a function, such as view resources folder at step 962, view job folder at step 966, or request resources from inventory at step 970. FIG. 16A shows the processing available if the client wants to look at its resources folder, as indicated at step 980. At step 982, the client selects the resource folder it wishes to view—either purchased materials (which had previously been automatically updated into that folder) at step 984 or it may edit or add resources to that folder at step 988. In the embodiments shown, resource manager 07 integrates with procurement function 04 so that when an order is invoiced by procurement function 04, it is automatically moved to the appropriate resources folder as long as it is tagged with the same job name. Any edits or changes made through resource manager 07 also update automatically into the appropriate folders. So, for example, if a client entered a change order before shipment reducing the quantity of an item already invoiced from 1000 to 800, resource manager 07 would automatically update the appropriate invoices and folders to reflect the change. At step 990 the client removes any resources no longer needed. At step 992, the client can print out a resource movement report to summarize the changes.

If the client is updating purchased materials into folders, the client can request, at step 986, that resource manager 07 print out a suggested equipment/purchase/rental needs report. Since, as will be described in more detail below, other jobs may be coming up for actual performance, this report takes into account any needs that can be determined from the current schedule of jobs for this client.

Briefly referring now to FIG. 20, a flow diagram for the suggested equipment/purchase/rental needs report feature of resource manager 07 is shown, with entry at step 1150. At step 1152, resource manager 07 finds and sorts by date all active job folders for the requesting client. Next, at step 1154, resource manager 07 checks each job folder to see if all that needs to be at the job site within a user specified time range is either there or scheduled for delivery to the site. Turning next to FIG. 21, it can be seen for jobname1 that item 1102, the 12 inch pipe ordered through the system is onsite, but that the client's own dump trailer and heavy bulldozers (items 1104 and 1106) are not, nor is item 1108, the rental heavy cement truck. Consequently, if these are needed within the specified time range, these items will be added to the suggested equipment/purchase/rental needs report. In addition, in the embodiments shown, if the rental item has not yet been rented, resource manager 07 provides a hypertext link to an appropriate equipment rental site on the Worldwide Web, such as United Rentals™ or NationsRent™, enabling the client to immediately arrange for the rental. In the embodiments shown, human resource requirements may also be met through temporary agencies for certain types of skills, so resource manager 07 can provide hypertext links to temporary agencies and similar resource locations online. Similarly, resource manager 07 can also provide links to a client's human resource inventory folders previously established.

In the embodiments shown, when rental or temporary sources are used, if the referenced source site permits, cost and similar data about the rental or temporary agreement are taken from the source website and automatically updated into the client's applicable job folder by resource manager 07.

Returning to FIG. 20, resource manager 07 checks at step 1156 to see if there are more upcoming jobs for this client, and if there are, processing returns to step 1154. If there are no more upcoming jobs, the data is summarized at step 1158 and printed out as a report at step 1160, before resource manager 07 exits at step 1162. Those skilled in the art will appreciate that the report can be simply displayed as a screen, if a hardcopy printout is not desired. Similarly, the report can be stored on disk, or sent as an e-mail, if desired.

With reference now to FIG. 16B, if the client has asked to view a job folder at step 1002, resource manager 07 prompts the client at step 1004 to enter totals. If daily totals are selected, the client enters the daily totals for resources on the calendar. For example, if a bulldozer was used for 4 hours at that job site, those totals would be entered. At step 1008, the client can remove that resource if it is no longer needed, and, at step 1010 print out a resource movement report, as well as a suggested equipment/purchase/rental report. Briefly, FIG. 22 shows an illustrative equipment movement report of the present invention. Returning to FIG. 16B, if the client has selected weekly totals, at step 1014, the client can enter them and at step 1016, resource manager 07 will give the client a summary of actual job costs versus estimates, if requested to do so. FIG. 23 shows such a summary 1204. In addition, in the embodiments shown, the client can also ask resource manager 07 to perform a rent versus buy analysis, such as that shown in FIG. 24. As seen there, “rent versus buy” report 1208 shows that the client has made heavy use of a rented 30 ton excavator, with annualized costs for the year 2000 averaging at $7500 a month, as seen at line 1212. Since most rental sources also sell equipment, resource manager 07 of the present is able to locate the purchase price for such an item, calculate a typical installment purchase loan at 10% interest financed over 36 months, to derive an ownership cash outlay of $5500 a month at line 1214. Using a simple cash flow criteria, resource manager 07 recommends at line 1216 that the client consider buying the item. Those skilled in the art will appreciate that additional criteria could be included in such an analysis, such as cost of ownership numbers, tax consequences, etc., without deviating from the spirit of the invention.

Now referring to FIG. 16C, if the client has requested resources from inventory at step 1020, it sets up a job schedule and calendar at step 1022 to which these resources will be transferred if this has not already been established. Once the resources are moved to the job folder and put on the schedule and calendar, a resource moving ticket is printed at step 1024, and at step 1026 resource manager 07 sees to it that the resource is moved to the job folder, and ultimately the jobsite. In the embodiments shown, the resource moving ticket is the authorization a crew member needs to move the resource from one location to another. FIG. 25 shows an illustrative equipment moving ticket 1220.

Now in FIG. 16C, if a requested resource is not available, resource manager 07 will refer the client to a rental site, such as those mentioned above, from which the appropriate equipment can be rented online and sent to the site. At step 1030 a rental needs report can be generated and at step 1032 a suggested equipment/purchase/rental report can be generated, if requested. In the embodiments shown, the reports must be requested by the user. However, as will be apparent to those skilled in the art, resource manager 07 could generate periodic reports on a scheduled basis or automatically update the relevant report when a significant change has occurred.

In FIG. 16C, still, if goods that can be ordered through procurement function 04 are the resources that are requested, these are automatically ordered by resource manager 07 at step 1034, the job folder is automatically updated with the orders at step 1036 and an acknowledgement of the order(s) placed is sent to the client at step 1038.

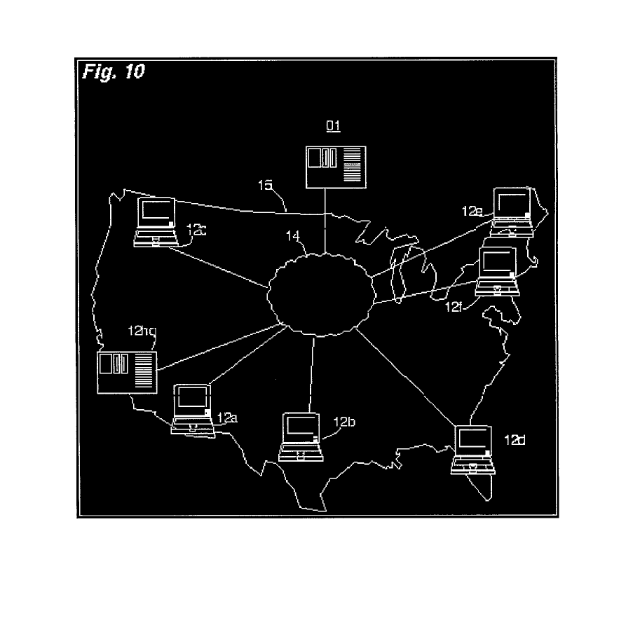

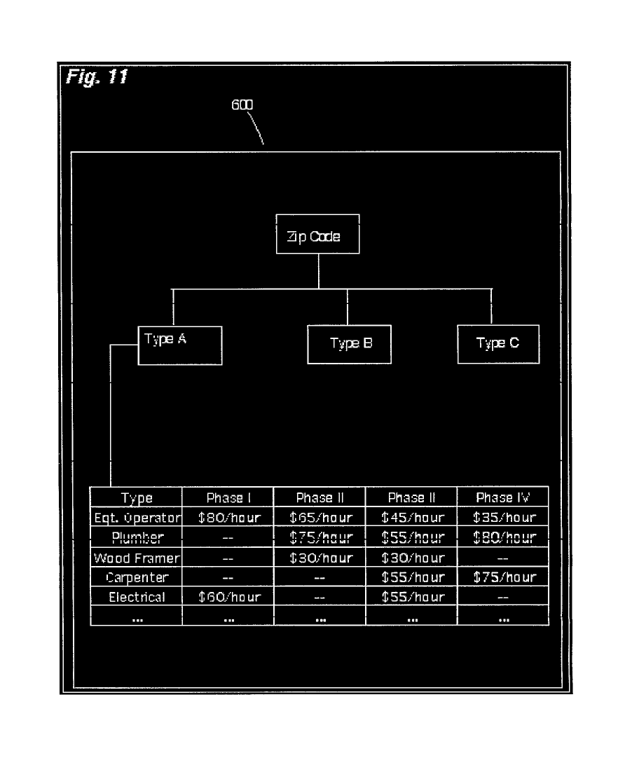

Turning now to FIG. 10, the virtual jobsite office features of the present invention are shown. In this example, a general contractor with headquarters 12hq, in California, is shown with multiple jobsite locations 12a through 12f throughout the US, as seen on map 15. At each jobsite location a laptop or desktop computer can be used by the manager or subcontractor at that site to communicate over the internet 14, or other network, using system 01 of the present invention, with headquarters 12hq. Previously, most contractors that operated on a large enough scale to have several jobsites active at once, used onsite trailers in which each local manager kept whiteboards or wall charts which were updated manually to reflect local status. With resource manager 07 of the present invention, a contractor can create an “instant” extranet to link such jobsites together in communication and to collect and share information. Authorization to read or update information at a local or overall level can be selected as described below.

Turning now to FIG. 26, resource manager 07 permits the client, at step 1300 to select authorization procedures. At step 1302, resource manager 07 checks to see if the client wishes to authorize a new person. If yes, the client proceeds to step 1304 to identify the new individual, create a password for him or her, and set a security level for that person. In the embodiments shown, three basic security levels are provided: read-only access to non-sensitive local information (this usually will not include cost information); read and write access to all local information and read and write access to all information for that client. Those skilled in the art will appreciate that additional or different levels of security could be provided without deviating from the spirit of the invention. If the client is not authorizing a new person, resource manager 07 checks at step 1308 to see if changes or removals are to be made to existing personnel. If they are, the changes are made at step 1310, providing the person presently using resource manager 07 is authorized to make such change. For either new or change processing, resource manager 07 exits at step 1306. If the authorization request was erroneous, it is noted at error exit at step 1312.

The embodiments shown of the present invention are implemented as programs written in the ASP programming language, with much of the database management and query processing written in SQL 2000™ from Microsoft Corporation. The invention operates on computers or workstations using the Windows TM operating systems. As will be apparent to those skilled in the art, other programming languages, such as C, C++, Perl, Java, etc., other relational databases and query structures, as well as other operating systems such as UNIX, LINUX, Windows NT, etc., could be used. Additionally, although the preferred embodiment uses a software program implementation, it will be apparent that some or all of the logic of the present invention could also be embodied in firmware or hardware circuitry. Those skilled in the art will appreciate that the embodiments described above are illustrative only and that other systems in the spirit of the teachings herein fall within the scope of the invention.

1. A system for estimating costs, purchasing goods and services, and managing resources for at least one designated location, comprising:
a gap analysis program for validating requested items against similar items valid for the designated location;
an estimator communicating with the gap analysis program for providing estimated costs of validated requested items;
a procurement function communicating with the gap analysis program for ordering validated requested items for the designated location;
a contractor locator for finding potential contractors for the designated location;
an automated auction program communicating with the procurement function for identifying the presence of a validated requested item available through auction;
a resource manager communicating with the procurement function, the estimator, the contractor locator and the automated auction program for managing resources at the designated location.

2. The system of claim 1, wherein the gap analysis program further comprises a integrity checker to verify that the requested item is internally consistent with other validated requested items.

3. The system of claim 1, wherein the estimator further comprises a phase labor calculator which permits the estimation of labor costs by phase of a project.

4. The system of claim 1, wherein the procurement function further comprises an ordering function for ordering validated requested items.

5. The system of claim 1, wherein the procurement function further comprises a credit check for verifying the credit.

6. The system of claim 1, wherein the procurement function further comprises a delivery handler for scheduling deliveries.

7. The system of claim 4, wherein the procurement function further comprises an inventory updater for automatically updating ordered validated requested items into an inventory.

8. The system of claim 1, wherein the resource manager further comprises a resource management program that enables the reservation and allocation of equipment, validated requested items and human resources, the scheduling of their use, and the tracking and reporting of costs associated with such use.

9. A method for estimating costs, purchasing goods and services, and managing resources for at least one designated location, comprising the steps of:
validating requested items against similar items valid for the designated location using a gap analysis program;
estimating costs of validated requested items through an estimator;
ordering validated requested items for the designated location through a procurement function;
locating potential contractors for the designated location using a contractor locator;
identifying the presence of a validated requested item available through auction using an automated auction program and communicating with the procurement function;
managing resources by communicating with the procurement function, the estimator, the contractor locator and the automated auction program to manage resources at the designated location.

10. The method of claim 9, wherein the step of validating requested items further comprises the step of checking the integrity of the requested item by verifying that it is internally consistent with other validated requested items.

11. The method of claim 9, wherein the step of estimating further comprises the step of estimating labor costs by phase of a project.

12. The method of claim 9, wherein the procurement function further comprises an ordering function for ordering validated requested items.

13. The method of claim 9, wherein the step of ordering further comprises the step of scheduling deliveries.

14. The method of claim 9, wherein the step of ordering further comprises the step of automatically updating ordered validated requested items into an inventory.

15. The method of claim 9, wherein the step of managing resources further comprises the steps of:
enabling the reservation and allocation of equipment, validated requested items and human resources;
the scheduling of their use; and
the tracking and reporting of costs associated with such use.
